(19) United States
(12) Patent Application Publication
(10) Pub. No.: US 2026/0358232 A1
(43) Pub. Date: Nov. 12, 2026

(54) PARTICLE MEASUREMENT DEVICE

(71) Applicant: OMRON Corporation, KYOTO (JP)

(72) Inventor: Tatsuo OGAKI, Kyoto-shi, KYOTO (JP)

(73) Assignee: OMRON Corporation, KYOTO (JP)

(21) Appl. No.: 19/139,364

(22) PCT Filed: Dec. 20, 2023
(86) PCT No.: PCT/JP2023/045699

§ 371 Date: Jun. 15, 2025

(30) Foreign Application Priority Data
Jan. 27, 2023 (JP) 2023-011125

(51) Int. Cl. G01N 15/1434; G01N 15/14

(52) U.S. Cl. CPC G01N 15/1434; G01N 2015/1493

(57) ABSTRACT

Provided is a particle measurement device capable of identifying a size and a material of a particle and having a small device size. A particle measurement device includes a light emitting part (25), a light receiving part (26), and a control part (27). The light emitting part (25) emits an irradiation light toward a detection region (42). The light receiving part (26) detects a passing light passing through the detection region (42). In the case where an over-time change occurs in a received light amount of the light receiving part (26), the control part (27) identifies a size of a particle that has passed through the detection region (42) by free fall based on a magnitude of the received light amount during the over-time change, and identifies a material of the particle based on a length of duration of the over-time change.

### TECHNICAL FIELD

The present invention relates to a particle measurement device.

### BACKGROUND ART

In recent years, various techniques have been proposed for detecting fine particles and the like. For example, in a particle counting device described in Patent Document 1 below, particles are guided to a flow cell, and laser light is irradiated into the flow path through which the particles pass. Then, a measurement part detects particles by receiving diffused light scattered by the particles. In addition, the measurement part is configured to classify particle diameters based on the diffused light amount of the diffused light, and count the number of particles for each particle diameter classification.

### RELATED ART DOCUMENTS

### Patent Documents

Patent Document 1: Japanese Patent Application Laid-Open No. 2009-30988

### SUMMARY OF INVENTION

### Problem to be Solved by Invention

However, in the above-described light diffusion method, since the size is determined based on the amount of diffuse reflection light from particles, the size identification performance decreases depending on the particle reflectivity. In addition, the above-described particle counting device cannot identify the material of particles. Furthermore, since coarse particles tend to fall without floating in the air, the detection part needs to be placed at the falling position of the particles. In addition, since a configuration with a particle flow path in a flow cell requires a suction mechanism such as a suction pump, the device size increases, leading to a problem that the device cannot be disposed if the space at the falling position of particles is narrow.

In an aspect, the present invention has been made in view of such problems, and an objective thereof is to provide a particle measurement device capable of identifying a size and a material of particles and having a small device size.

### Means for Solving Problem

The present invention adopts the following configuration to solve the above-mentioned problems.

That is, a particle measurement device according to an aspect of the present invention includes a light emitting part, a light receiving part, and a control part. The light emitting part emits an irradiation light toward a detection region. The light receiving part detects a passing light passing through the detection region. In a case where an over-time change occurs in a received light amount of the light receiving part, the control part identifies a size of a particle that has passed through the detection region by free fall based on a magnitude of the received light amount during the over-time change, and identifies a material of the particle based on a length of duration of the over-time change.

### Effects of Invention

According to the present invention, it is possible to provide a particle measurement device capable of identifying a size and a material of particles and having a small device size.

### BRIEF DESCRIPTION OF THE DRAWINGS

FIG. 1 is an external perspective view schematically showing an example of a particle measurement device according to Embodiment 1.

FIG. 2 is a perspective view schematically showing an example of a schematic configuration of a detection part detecting particles according to Embodiment 1.

FIG. 3 is a block diagram showing an example of an electrical configuration of the particle measurement device according to Embodiment 1.

FIG. 4 is a functional block diagram of a control part included in the particle measurement device according to Embodiment 1.

FIG. 5 is a view schematically showing an example of a detection signal of a light receiving part when a particle falls through a flow path part.

FIG. 6 is a view showing an example of falling velocities for each particle diameter classification during free fall of ABS resin, aluminum, and copper.

FIG. 7 is a main flowchart showing an example of a particle measurement processing executed by the control part.

FIG. 8 is a sub-flowchart showing an example of a sub-processing of a measurement processing in FIG. 7.

FIG. 9 is a sub-flowchart showing an example of a sub-processing of an output display processing in FIG. 7.

FIG. 10 is a view showing an example of output display of measurement results.

FIG. 11 is a perspective view schematically showing an example of a schematic configuration of a detection part detecting particles according to Embodiment 2.

FIG. 12 is a perspective view schematically showing an example of a schematic configuration of a detection part detecting particles of a particle measurement device according to Modification Example 5.

FIG. 13 is an external perspective view schematically showing an example of a particle measurement device according to Modification Example 6.

FIG. 14 is a view showing an example of output display of measurement results in a host device according to Modification Example 7.

### EMBODIMENTS FOR IMPLEMENTING INVENTION

Hereinafter, Embodiment 1 and Embodiment 2, which embody the present invention, will be described in detail with reference to the drawings. Same or equivalent constituent elements and members shown in each drawing will be labeled with the same reference signs, and repeated descriptions will be appropriately omitted.

### § 1 Application Example

### Embodiment 1

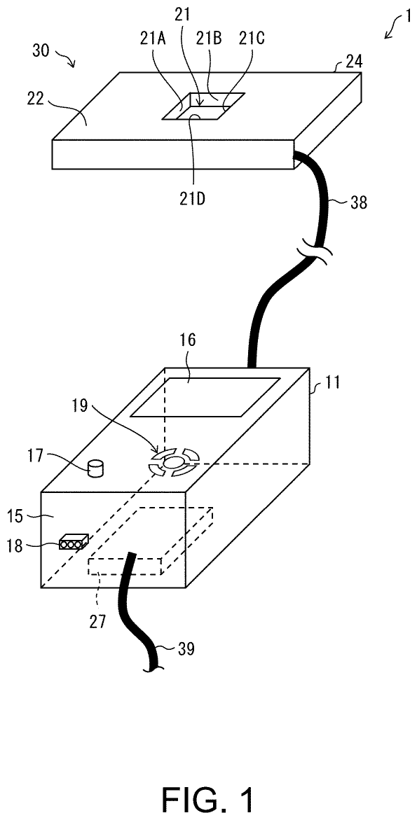

First, with reference to FIG. 1, an example of a particle measurement device to which the present invention is applied will be described. FIG. 1 is an external perspective view schematically showing an example of a particle measurement device according to Embodiment 1. As shown in FIG. 1, the particle measurement device 1 according to Embodiment 1 includes a box-shaped main body case 11, a box-shaped detection part 30 with a small height, and a signal line 38 that electrically connects the main body case 11 and the detection part 30.

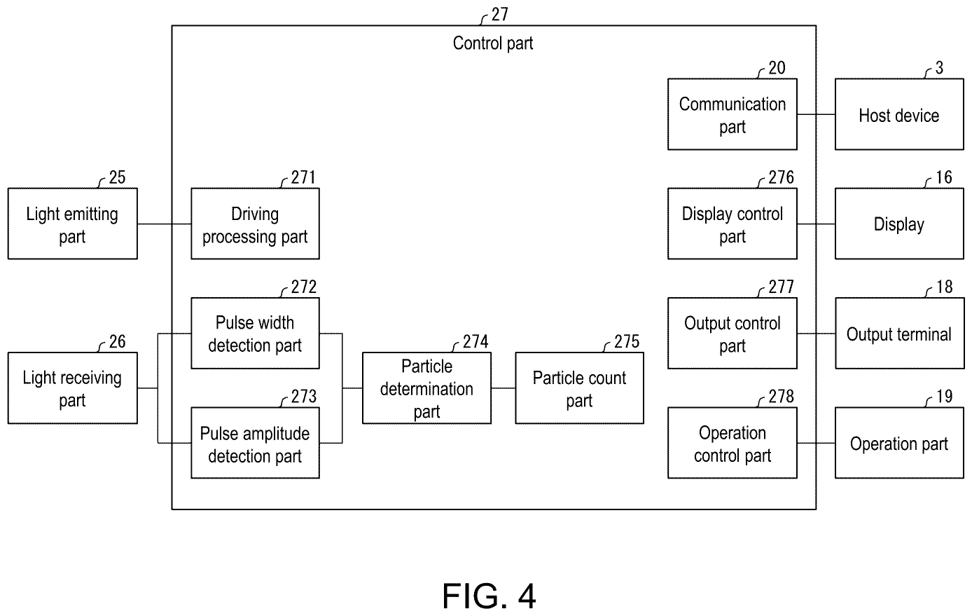

As shown in FIG. 1, the main body case 11 has a display 16, a power switch 17, and an operation part 19 that are disposed on the upper surface. The main body case 11 has an output terminal 18 disposed on a front side wall surface 15 on the near side, and furthermore, a communication cable 39 that electrically connects a host device 3 (see FIG. 4) such as a PC and the main body case 11 in a communicable manner is drawn out from the front side wall surface 15.

The display 16 is composed of a liquid crystal display, an organic EL display, etc. As will be described later, the display 16 displays detection results including the material such as metal or plastic of small particles, the size of particles for each type of material, the number of passed particles for each size range of particles and each type of material of particles, etc. The power switch 17 is a switch that turns on and off the power of the particle measurement device 1.

The output terminal 18 is a terminal that outputs measurement results obtained by the particle measurement device 1 to an external device that is electrically connected. The operation part 19 is composed of multiple button switches, and by pressing the surrounding button switches, a cursor displayed on the display 16 moves. In addition, by pressing the central button switch of the operation part 19, the input of various instruction buttons at which the cursor is located is decided. The particle diameter that the particle measurement device 1 detects is, for example, 10 [μm] to 500 [μm] and the like.

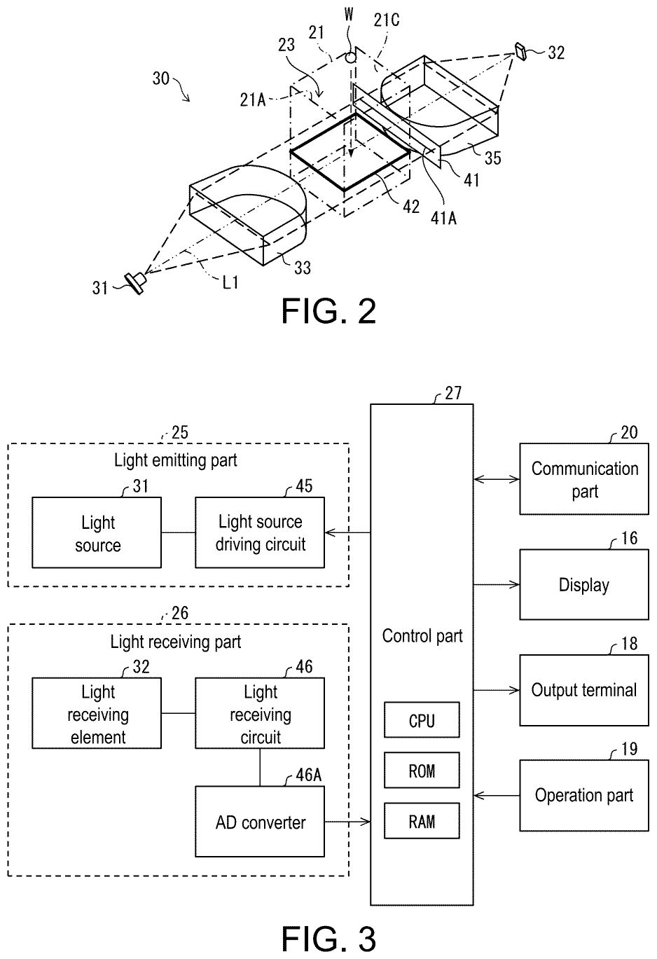

On a top surface 22, which is approximately rectangular and flat, of the sensor case 24 of the detection part 30, a flow path part 21 with an approximately rectangular cross-section, through which small particles falling in the air are capable of entering, is formed penetrating along a particle passing direction (vertical direction) in which particles pass. The flow path part 21 has an approximately rectangular cross-section formed by each wall surface 21A to 21D and constitutes an internal space 23 (see FIG. 2) that penetrates along the vertical direction. Thus, small particles that have entered the flow path part 21 fall freely through the internal space 23. The wall surfaces 21A and 21C are formed of transparent resin or the like and are configured to allow light to pass through.

In Embodiment 1, since particles pass through the flow path part 21 by free fall, the particle passing direction is the vertical direction. In addition, a suction pump or the like for drawing particles into the flow path part 21 is not provided. Accordingly, a particle measurement device 1 with a small device size can be provided.

In addition, in the detection part 30, a light emitting part 25 (see FIG. 3) and a light receiving part 26 (see FIG. 3) for detecting small particles entering the flow path part 21 and falling through the internal space 23 are disposed with the wall surfaces 21A and 21C interposed therebetween (see FIG. 2). In addition, as shown in FIG. 1, a control part 27 is disposed in the main body case 11. As will be described later, the control part 27 calculates the material such as metal or plastic of small particles, the size of particles for each type of material, the number of particles for each size range of particles and each type of material of particles, etc., based on the pulse width and amplitude of a pulse-shaped particle detection signal inputted from the light receiving part 26.

### § 2 Configuration Example

Next, the detection part 30 detecting small particles will be described based on FIG. 2. FIG. 2 is a perspective view schematically showing an example of a schematic configuration of the detection part 30 which detects particles. As shown in FIG. 2, in the detection part 30, a light source 31 and a light receiving element 32 are disposed opposed to each other, with the wall surfaces 21A and 21C of the flow path part 21 interposed therebetween. A light emitting-side lens 33 is disposed between the light source 31 and the wall surface 21A. A light receiving-side lens 35 is disposed between the light receiving element 32 and the wall surface 21C.

The light emitting-side lens 33 is an optical member for collimating light emitted from the light source 31 and irradiating the light to the flow path part 21 across the entire width of the wall surface 21A as an approximately parallel light perpendicular to the vertical direction. The light emitting-side lens 33 functions as an example of a collimating lens. The light receiving-side lens 35 is an optical member that collects the approximately parallel light passing through the flow path part 21 across the entire width of the wall surface 21C and directs the light to the light receiving element 32. The optical axis of the irradiation light irradiated from the light source 31 via the light emitting-side lens 33 and the optical axis of the incident light received by the light receiving element 32 via the light receiving-side lens 35 are disposed to be located on a same optical axis L1 that is orthogonal to the vertical direction.

In addition, between the wall surface 21C of the flow path part 21 and the light receiving-side lens 35, a slit member 41 in an approximately rectangular plate shape formed of an opaque resin plate or metal plate that does not transmit light is disposed parallel to the wall surface 21C. The height of the slit member 41 in the vertical direction is formed to cover the wall surface 21C until both outer sides in the vertical direction beyond the light receiving-side lens 35. The width of the slit member 41 is formed to cover until both outer sides in a direction orthogonal to the vertical direction beyond the wall surface 21C.

In the slit member 41, a narrow-width slit 41A is formed along a direction orthogonal to the vertical direction, i.e., along the horizontal direction, at a position through which the optical axis L1 passes. Both ends of the slit 41A in the direction orthogonal to the vertical direction are formed to be opposed to outer sides of both side edges of the wall surface 21C.

As a result, among the collimated light irradiated into the flow path part 21 via the light emitting-side lens 33, the region capable of passing through the slit 41A and reaching the light receiving element 32 via the light receiving-side lens 35 becomes a detection region 42 capable of detecting particles W falling through the flow path part 21. Thus, a cross-sectional region corresponding to the detection region 42 in the internal space 23 of the flow path part 21 all becomes the region detecting particles W.

The slit 41A restricts the light receiving range in the vertical direction, and light that is irradiated to the light receiving-side lens 35 and the light receiving element 32 from outside the detection region 42 is blocked. The slit 41A has the effect of making the light blocking amount almost uniform regardless of the falling position of the particle W. The slit 41A is disposed to increase a change amount due to the particle W with respect to the total received light amount of the light receiving element 32. The slit member 41 may also be disposed between the light emitting-side lens 33 and the wall surface 21A of the flow path part 21.

The light source 31 is a light source that emits light of a specific wavelength upon power supply and may be, for example, an LED (light emitting diode) element or a semiconductor laser. The wavelength emitted by the light source 31 is within the light receiving band range of the light receiving element 32 and may be, for example, infrared light, red light, green light, blue light, near-ultraviolet light, etc. When using a green LED as the light source 31, since the wavelength of the irradiation light is shorter than infrared light or red light, it becomes less likely to be affected by diffraction, and a signal change due to position further decreases.

The light receiving element 32 receives light of a specific wavelength and converts the optical signal into an electrical signal, and may be, for example, a photodiode or the like.

Next, an example of the electrical configuration of the particle measurement device 1 will be described based on FIG. 3. FIG. 3 is a block diagram showing an example of the electrical configuration of the particle measurement device 1 according to Embodiment 1. As shown in FIG. 3, the particle measurement device 1 includes a light emitting part 25, a light receiving part 26, a control part 27, a display 16, an output terminal 18, an operation part 19, and a communication part 20. The communication part 20 is an example of a communication interface for communicating with a host device 3 (see FIG. 4) such as a PC.

The light emitting part 25 includes a light source 31 and a light source driving circuit 45 electrically connected to the light source 31. The light receiving part 26 includes a light receiving element 32, a light receiving circuit 46 electrically connected to the light receiving element 32, and an AD converter 46A electrically connected to the light receiving circuit 46.

The light source driving circuit 45 supplies a driving current based on a light emitting signal from the control part 27. As a result, the light source 31 emits light of a specific wavelength.

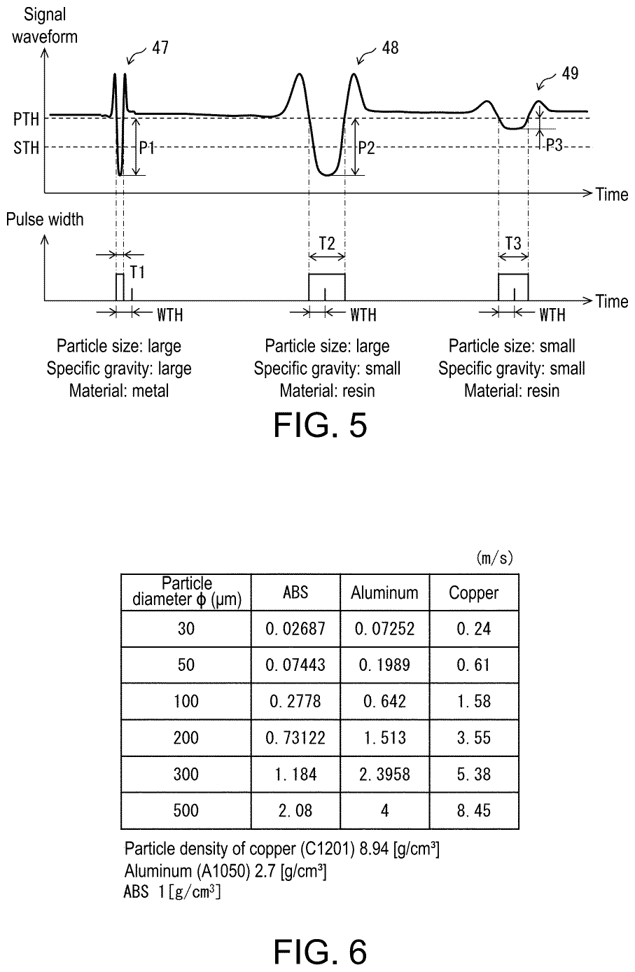

The light receiving circuit 46 converts a current signal generated by the light receiving element 32 into a voltage value and amplifies it, and then converts the voltage value, which is an analog signal, into a digital signal by the AD converter 46A and outputs to the control part 27. Specifically, since the received light amount of the light receiving element 32 decreases due to the particle W falling into the detection region 42, the light receiving circuit 46 receives a pulse-shaped current signal corresponding to the change in received light amount from the light receiving element 32 (see FIG. 5). The light receiving circuit 46 converts the pulse-shaped current signal inputted from the light receiving element 32 into a voltage value and amplifies it, and then converts the voltage value which is an analog signal into a digital signal by the AD converter 46A and outputs to the control part 27.

The control part 27 is a so-called conventional digital signal processing circuit including a CPU, a ROM (such as a flash memory) as a non-volatile memory, a RAM, etc. The CPU executes various calculation processings based on various programs and various parameters stored in the ROM. The RAM temporarily stores calculation results from the CPU and data inputted from the light receiving part 26.

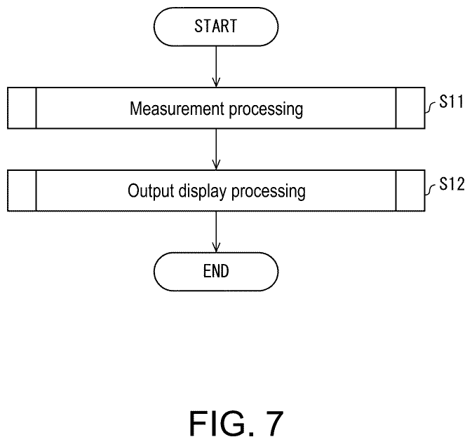

The ROM stores, for example, a program of a particle measurement processing (see FIG. 7) (to be described later) that detects the material of particles falling through the flow path part 21, the size of particles for each type of material, the number of passed particles for each size range of particles and each type of material of particles, etc. The control part 27 may also be composed of an FPGA (field programmable gate array), an ASIC (application specific IC), etc.

FIG. 4 is a functional block diagram of the control part 27. As shown in FIG. 4, the control part 27 includes a driving processing part 271, a pulse width detection part 272, a pulse amplitude detection part 273, a particle determination part 274, a particle count part 275, a display control part 276, an output control part 277, an operation control part 278, and a communication part 20. The driving processing part 271 is electrically connected with the light source driving circuit 45 and outputs a light emitting signal, which instructs a driving current to be supplied to the light source 31, to the light source driving circuit 45.

The pulse width detection part 272 is electrically connected with the light receiving circuit 46 via the AD converter 46A, and detects a pulse width PW of the detection signal of the particle W inputted from the light receiving circuit 46 and outputs to the particle determination part 274. In addition, the pulse amplitude detection part 273 is electrically connected with the light receiving circuit 46 via the AD converter 46A, and detects an amplitude value P (minimum value) of the detection signal of the particle W inputted from the light receiving circuit 46 and outputs to the particle determination part 274.

The particle determination part 274 identifies the material of the particle W based on the pulse width PW of the detection signal inputted from the pulse width detection part 272, and outputs to the particle count part 275. In addition, the particle determination part 274 identifies the size of the particle W based on the amplitude value P of the detection signal inputted from the pulse amplitude detection part 273, and outputs to the particle count part 275. The particle count part 275 counts a particle detection count for each size range of the particle W and each type of material of the particle. In addition, the particle count part 275 counts a total particle detection count. Thus, since the particle determination part 274 identifies the size of the particle W based on the amplitude value P of the detection signal inputted from the pulse amplitude detection part 273, i.e., based on the magnitude of a received light amount change, it is not affected by the reflectivity of the particle W.

Herein, an example of the detection signal outputted from the light receiving circuit 46 when a particle W passes through the detection region 42 will be described based on FIG. 5. FIG. 5 is a view schematically showing an example of the detection signal of the light receiving part 26 when a particle W falls through the flow path part 21.

As shown on the left side of FIG. 5, in a detection signal 47 outputted from the light receiving circuit 46, with a particle W passing through the detection region 42, the received light amount decreases until an amplitude value P1 (minimum value) exceeding an amplitude threshold PTH. Thus, the pulse amplitude detection part 273 detects the amplitude value P1 of the detection signal 47 and outputs to the particle determination part 274. The decrease in the received light amount increases as the particle size increases. Since the inputted amplitude value P1 exceeds a size threshold STH, the particle determination part 274 determines that the particle size of the particle W is “large”. The size threshold STH is stored in the ROM in advance.

In addition, the pulse width detection part 272 detects a pulse width T1 at the amplitude threshold PTH of the detection signal 47 inputted from the light receiving circuit 46, and outputs to the particle determination part 274. Since the inputted pulse width T1 is equal to or less than a pulse width threshold WTH, the particle determination part 274 determines that the specific gravity of the particle W is large and the material is “metal”. Then, the particle determination part 274 outputs the determination results that the particle size is “large” and the material is “metal” to the particle count part 275. The pulse width threshold WTH is stored in the ROM in advance.

In addition, as shown in the center of FIG. 5, in a detection signal 48 outputted from the light receiving circuit 46, with a particle W passing through the detection region 42, the received light amount decreases until an amplitude value P2 (minimum value) exceeding the amplitude threshold PTH. Thus, the pulse amplitude detection part 273 detects the amplitude value P2 of the detection signal 48 and outputs to the particle determination part 274. Since the inputted amplitude value P2 exceeds the size threshold STH, the particle determination part 274 determines that the particle size of the particle W is “large”.

In addition, the pulse width detection part 272 detects a pulse width T2 at the amplitude threshold PTH of the detection signal 48 inputted from the light receiving circuit 46, and outputs to the particle determination part 274. Since the inputted pulse width T2 is greater than the pulse width threshold WTH, the particle determination part 274 determines that the specific gravity of the particle W is small and the material is “resin”. Then, the particle determination part 274 outputs the determination results that the particle size is “large” and the material is “resin” to the particle count part 275.

In addition, as shown on the right side of FIG. 5, in the detection signal 49 outputted from the light receiving circuit 46, with a particle W passing through the detection region 42, the received light amount decreases until an amplitude value P3 (minimum value) exceeding the amplitude threshold PTH. Thus, the pulse amplitude detection part 273 detects the amplitude value P3 of the detection signal 49 and outputs to the particle determination part 274. Since the inputted amplitude value P3 does not exceed the size threshold STH, the particle determination part 274 determines that the particle size of the particle W is “small”.

In addition, the pulse width detection part 272 detects a pulse width T3 at the amplitude threshold PTH of the detection signal 49 inputted from the light receiving circuit 46, and outputs to the particle determination part 274. Since the inputted pulse width T3 is greater than the pulse width threshold WTH, the particle determination part 274 determines that the specific gravity of the particle W is small and the material is “resin”. Then, the particle determination part 274 outputs the determination results that the particle size is “small” and the material is “resin” to the particle count part 275.

Herein, the relationship between the settling velocity (falling velocity) of a particle falling through the internal space 23 of the flow path part 21 and the material of the particle will be described. A settling velocity (falling velocity) v [cm/s] of a particle freely falling through the internal space 23 of the flow path part 21 may be calculated, for example, according to Stokes equation (1) below.

v={(ρs−ρw)×g×d²}/18η (1)
ρs: particle density [g/cm³], ρw: fluid density of air 1.2×10⁻³ [g/cm³], g: gravitational acceleration 980 [cm/s²], η: fluid viscosity of air 1.8×10⁻⁴ [g/cm³], d: particle diameter [cm].

An example of the falling velocity for each particle diameter classification during free fall of ABS resin, aluminum, and copper, calculated according to Stokes equation (1) above, will be described based on FIG. 6. FIG. 6 is a view showing an example of the falling velocity for each particle diameter classification during free fall of ABS resin, aluminum, and copper. The particle density of ABS resin is taken as 1 [g/cm³]. The particle density of aluminum is taken as 2.7 [g/cm³]. The particle density of copper is taken as 8.94 [g/cm³].

As shown in FIG. 6, for example, in the case of a particle diameter of 100 [μm], the falling velocity of ABS resin is 27.78 [cm/s], the falling velocity of aluminum is 64.2 [cm/s], and the falling velocity of copper is 158 [cm/s]. Accordingly, the time to fall 1 [mm] in the flow path part 21 is 3.6 [msec] in the case of ABS resin, is 1.6 [msec] in the case of aluminum, and is 0.6 [msec] in the case of copper. Thus, by configuring the pulse width threshold WTH in the case of a particle diameter of 100 [μm] to, for example, 2.0 [msec], it becomes possible for the particle determination part 274 to distinguish the material of the particle W between “resin” and “metal”.

In addition, as shown in FIG. 4, the operation control part 278 is electrically connected with multiple button switches of the operation part 19, and operation signals from each button switch are inputted. The display control part 276 is electrically connected to the display 16 and displays, on the display 16, detected results such as the particle detection count and the total particle detection count for the size range and the type of material of particles W falling through the flow path part 21, as selected via the operation part 19.

In the case where another device is electrically connected to the output terminal 18, the output control part 277 outputs the measurement results to the another device from the output terminal 18. The communication part 20 transmits, to the host device 3 such as a PC via the communication cable 39, the detected results such as the particle detection count and the total particle detection count for each size range of particles W falling through the flow path part 21 and each type of material of particles.

### § 3 Action Example

Next, an example will be described based on FIG. 7 to FIG. 10 for the particle measurement processing which detects the number of particles W for each size range of particles W falling through the flow path part 21 and each type of material of particles W and is executed by the control part 27 of the particle measurement device 1 configured as described above. FIG. 7 is a main flowchart showing an example of the particle measurement processing executed by the control part 27.

In the case of being activated, the control part 27 repeatedly executes the processing procedure shown in the flowchart of FIG. 7 at specific time intervals (e.g., at approximately 1 to 2 minute intervals). The program shown in the flowcharts of FIG. 7 to FIG. 9 is stored in advance in the ROM. In addition, the amplitude threshold PTH, the size threshold STH, the pulse width threshold WTH, and a maximum measurement time TM are stored in advance in the ROM.

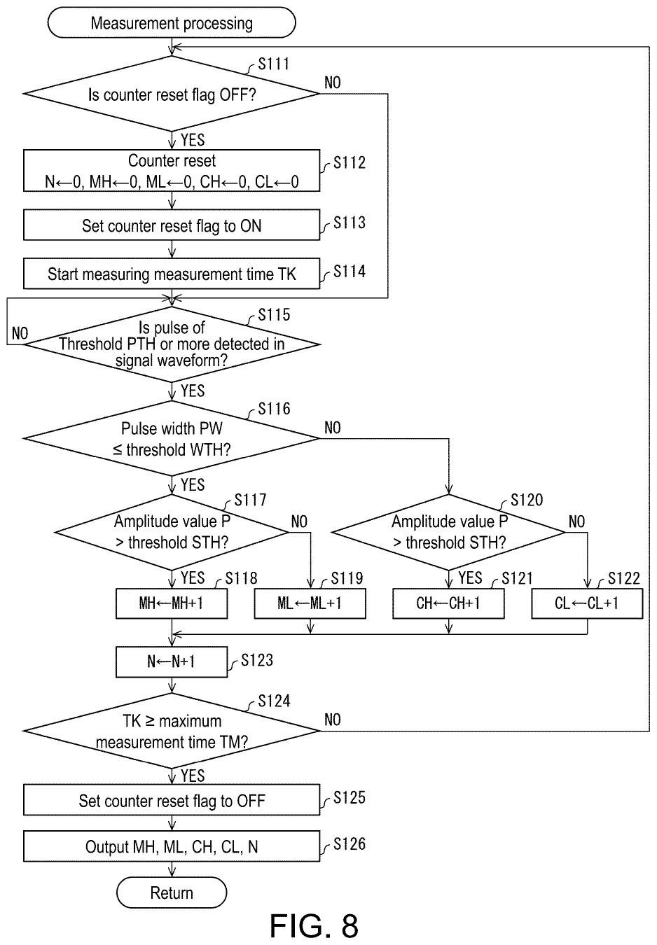

As shown in FIG. 7, first, at step S11, the control part 27 executes a sub-processing of a measurement processing (see FIG. 8) (to be described later) for a specific time (e.g., for approximately 1 to 2 minutes), and then proceeds to step S12. By executing the sub-processing of the measurement processing, the control part 27 detects the size of particles W falling through the internal space 23 of the flow path part 21 and the material of the particles W. Then, the control part 27 counts the particle detection count for each size range of particles W and each type of material of particles W.

In addition, the control part 27 also counts the total particle detection count of particles W falling through the internal space 23 of the flow path part 21. Then, the control part 27 transmits the particle detection count for each size range of particles W and each type of material of particles W and the total particle detection count to the host device 3 such as a PC via the communication part 20.

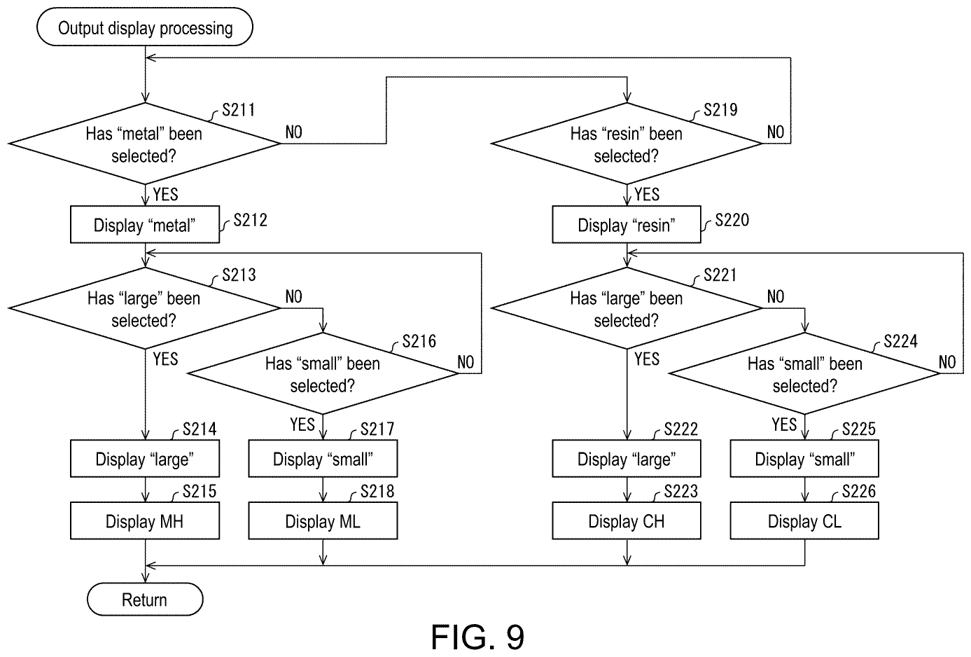

At step S12, the control part 27 executes a sub-processing of an output display processing (see FIG. 9) (to be described later), and then ends the particle measurement processing. By executing the sub-processing of the output display processing via the display control part 276, the control part 27 displays, on the display 16, the particle detection count for the material of particles W and the size of particles W selected via the operation part 19.

In the case where another device is electrically connected to the output terminal 18, the control part 27 outputs the measurement result from the output terminal 18 to the another device via the output control part 277.

Next, details of the sub-processing of the measurement processing executed by the control part 27 in the above step S11 will be described based on FIG. 8. FIG. 8 is a sub-flowchart showing an example of the sub-processing of the measurement processing. As shown in FIG. 8, first, at step S111, the control part 27 reads a counter reset flag from the RAM and determines whether it is set to OFF. The counter reset flag is set to OFF and stored in the RAM at the time of activation of the control part 27.

Then, in the case of determining that the counter reset flag is set to ON (S111: NO), the control part 27 proceeds to step S115 to be described later. On the other hand, in the case of determining that the counter reset flag is set to OFF (S111: YES), the control part 27 proceeds to step S112.

At step S112, the control part 27 reads a count value N, a count value MH, a count value ML, a count value CH, and a count value CL from the RAM. Then, the control part 27 assigns “0” to each of the count values N, MH, ML, CH, and CL, stores to the RAM again, and then proceeds to step S113. At step S113, the control part 27 reads the counter reset flag from the RAM, sets the counter reset flag to ON, stores to the RAM again, and then proceeds to step S114.

Herein, the count value N is a count value of a counter that counts the total particle detection count of particles W detected passing through the detection region 42 in the flow path part 21. The count value MH is a count value that counts the particle detection count of particles with a particle size being “large” among metal particles such as aluminum detected passing through the detection region 42. The count value ML is a count value that counts the particle detection count of particles with a particle size being “small” among metal particles such as aluminum detected passing through the detection region 42.

The count value CH is a count value that counts the particle detection count of particles with a particle size being “large” among resin particles such as ABS, i.e., non-metal particles, detected passing through the detection region 42. The count value CL is a count value that counts the particle detection count of particles with a particle size being “small” among resin particles such as ABS, i.e., non-metal particles, detected passing through the detection region 42.

Herein, the particle size being “large” refers to, for example, a size at which the particle diameter of the particle W is 100 [μm] or more. In addition, the particle size being “small” refers to, for example, a size at which the particle diameter of the particle W is smaller than 100 [μm].

At step S114, the control part 27 starts measuring the measurement time TK detecting particles W passing through the detection region 42, and then proceeds to step S115. At step S115, the control part 27 determines, via the pulse amplitude detection part 273, whether a pulse with an amplitude value P (minimum value) being equal to or greater than the amplitude threshold PTH has been detected in the detection signal of the particle W inputted from the light receiving circuit 46.

Then, in the case of determining that a pulse with an amplitude value P (minimum value) being equal to or greater than the amplitude threshold PTH has not been detected in the detection signal of the particle W inputted from the light receiving circuit 46 (S115: NO), the control part 27 executes the processing of step S115 again. On the other hand, in the case of determining that a pulse with an amplitude value P (minimum value) being equal to or greater than the amplitude threshold PTH has been detected in the detection signal of the particle W inputted from the light receiving circuit 46 (S115: YES), the control part 27 proceeds to step S116.

At step S116, the control part 27 determines, via the particle determination part 274, whether a pulse width PW at the amplitude threshold PTH of the detection signal of the particle W inputted from the light receiving circuit 46 is equal to or less than the pulse width threshold WTH. Then, in the case of determining that the pulse width PW at the amplitude threshold PTH of the detection signal of the particle W inputted from the light receiving circuit 46 is equal to or less than the pulse width threshold WTH (S116: YES), the control part 27 proceeds to step S117. That is, the control part 27 determines that the particle W detected passing through the detection region 42 is a metal particle such as aluminum, and proceeds to step S117.

At step S117, the control part 27 determines, via the particle determination part 274, whether the amplitude value P of the detection signal of the particle W inputted from the light receiving circuit 46 exceeds the size threshold STH. Then, in the case of determining that the amplitude value P of the detection signal of the particle W inputted from the light receiving circuit 46 exceeds the size threshold STH (S117: YES), the control part 27 proceeds to step S118. At step S118, the control part 27 reads, from the RAM, the count value MH that counts the particle detection count of particles with a particle size being “large” among metal particles such as aluminum detected passing through the detection region 42. Then, the control part 27 adds “1” to the count value MH, stores to the RAM again, and then proceeds to step S123 to be described later.

In the case of determining that the amplitude value P of the detection signal of the particle W inputted from the light receiving circuit 46 does not exceed the size threshold STH (S117: NO), the control part 27 proceeds to step S119. At step S119, the control part 27 reads, from the RAM, the count value ML that counts the particle detection count of particles with a particle size being “small” among metal particles such as aluminum detected passing through the detection region 42. Then, the control part 27 adds “1” to the count value ML, stores to the RAM again, and then proceeds to step S123 to be described later.

On the other hand, at the above step S116, in the case of determining that the pulse width PW at the amplitude threshold PTH of the detection signal of the particle W inputted from the light receiving circuit 46 is greater than the pulse width threshold WTH (S116: NO), the control part 27 proceeds to step S120. That is, the control part 27 determines that the particle W detected passing through the detection region 42 is a resin particle such as ABS, i.e., a non-metal particle, and proceeds to step S120.

At step S120, the control part 27 determines, via the particle determination part 274, whether the amplitude value P of the detection signal of the particle W inputted from the light receiving circuit 46 exceeds the size threshold STH. Then, in the case of determining that the amplitude value P of the detection signal of the particle W inputted from the light receiving circuit 46 exceeds the size threshold STH (S120: YES), the control part 27 proceeds to step S121. At step S121, the control part 27 reads, from the RAM, the count value CH that counts the particle detection count of particles with a particle size being “large” among resin particles such as ABS detected passing through the detection region 42. Then, the control part 27 adds “1” to the count value CH, stores to the RAM again, and then proceeds to step S123 to be described later.

On the other hand, in the case of determining that the amplitude value P of the detection signal of the particle W inputted from the light receiving circuit 46 does not exceed the size threshold STH (S120: NO), the control part 27 proceeds to the processing of step S122. At step S122, the control part 27 reads, from the RAM, the count value CL that counts the particle detection count of particles with a particle size being “small” among resin particles such as ABS detected passing through the detection region 42. Then, the control part 27 adds “1” to the count value CL, stores to the RAM again, and then proceeds to step S123.

At step S123, the control part 27 reads, from the RAM, the count value N of the counter that counts the total particle detection count of particles W detected passing through the detection region 42 in the flow path part 21. Then, the control part 27 adds “1” to the count value N, stores to the RAM again, and then proceeds to step S124. At step S124, the control part 27 reads, from the RAM, the measurement time TK detecting particles W passing through the detection region 42, and determines whether the measurement time TK has become equal to or greater than the maximum measurement time TM, i.e., whether the measurement time TK has reached the maximum measurement time TM. The maximum measurement time TM corresponds to an execution time of a specific time, e.g., an execution time of about 1 to 2 minutes.

Then, in the case of determining that the measurement time TK has not reached the maximum measurement time TM (S124: NO), the control part 27 executes the processing from step S111 onward again. On the other hand, in the case of determining that the measurement time TK has reached the maximum measurement time TM (S124: YES), the control part 27 proceeds to step 125. At step S125, the control part 27 reads the counter reset flag from the RAM, sets the counter reset flag to OFF, stores to the RAM again, and then proceeds to step S126.

At step S126, the control part 27 reads the count value N, the count value MH, the count value ML, the count value CH, the count value CL, and the count value N from the RAM, and transmits to the host device 3 via the communication part 20. Afterward, the control part 27 ends the sub-processing of the measurement processing, returns to the main flowchart, and proceeds to step S12.

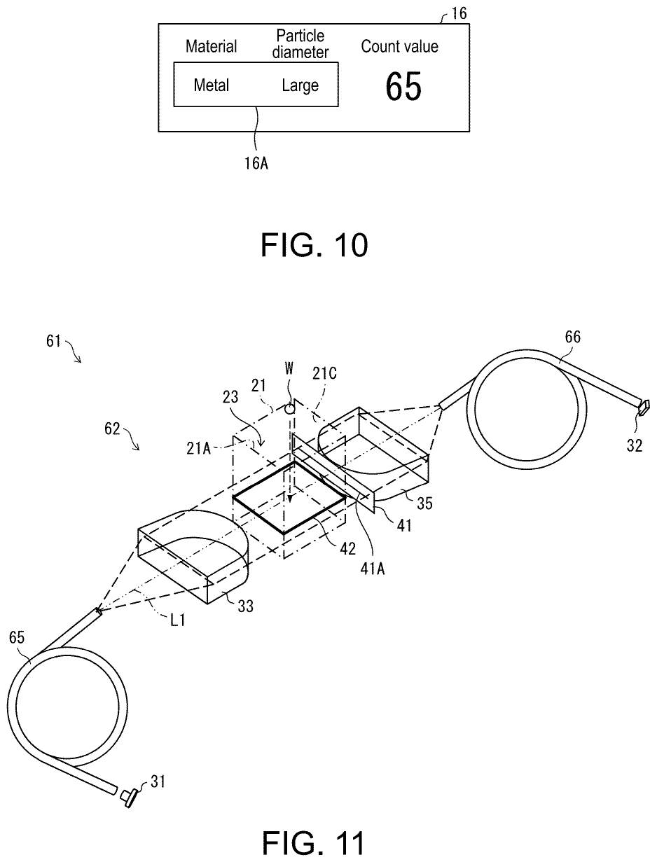

Next, details of the sub-processing of the output display processing executed by the control part 27 in the above step S12 will be described based on FIG. 9 and FIG. 10. FIG. 9 is a sub-flowchart showing an example of the sub-processing of the output display processing. FIG. 10 is a view showing an example of output display of a measurement result.

As shown in FIG. 9, at step S211, the control part 27 determines whether “metal” has been selected via the operation part 19 as the material for displaying the particle detection count on the display 16. Then, in the case of determining that “metal” has been selected via the operation part 19 as the material for displaying the particle detection count on the display 16 (S211: YES), the control part 27 proceeds to step S212.

At step S212, the control part 27 displays “metal” as the material for displaying the particle detection count on the display 16, and then proceeds to step S213. For example, as shown in FIG. 10, the control part 27 displays “metal” below “material” of a target display part 16A of the display 16, and then proceeds to step S213.

At step S213, the control part 27 determines whether “large” has been selected via the operation part 19 as the particle size of metal particles. Then, in the case of determining that “large” has been selected via the operation part 19 as the particle size of metal particles (S213: YES), the control part 27 proceeds to step S214. At step S214, the control part 27 displays “large” as the particle size for displaying the particle detection count on the display 16, and then proceeds to step S215. For example, as shown in FIG. 10, the control part 27 displays “large” below “particle diameter” of the target display part 16A of the display 16, and then proceeds to step S215.

At step S215, the control part 27 reads, from the RAM, the count value MH that counts the particle detection count of particles with a particle size being “large” among metal particles such as aluminum. Then, the control part 27 displays the count value MH on the display 16, then ends the sub-processing of the output display processing, returns to the main flowchart, and ends the particle measurement processing.

For example, as shown in FIG. 10, the control part 27 displays, for example, “65” below “count value” on the right side of the target display part 16A of the display 16. Accordingly, a user can easily confirm that the particle detection count of particles with a particle size being “large” among metal particles such as aluminum is “65”.

At the above step S213, in the case of determining that “large” has not been selected via the operation part 19 as the particle size of metal particles (S213: NO), the control part 27 proceeds to step S216. At step S216, the control part 27 determines whether “small” has been selected via the operation part 19 as the particle size of metal particles. Then, in the case of determining that “small” has not been selected via the operation part 19 as the particle size of metal particles (S216: NO), the control part 27 executes the processing from step S213 onward again.

On the other hand, in the case of determining that “small” has been selected via the operation part 19 as the particle size of metal particles (S216: YES), the control part 27 proceeds to step S217. At step S217, the control part 27 displays “small” as the particle size for displaying the particle detection count on the display 16, and then proceeds to step S218. For example, the control part 27 displays “small” below “particle diameter” of the target display part 16A (see FIG. 10) of the display 16, and then proceeds to step S218.

At step S218, the control part 27 reads, from the RAM, the count value ML that counts the particle detection count of particles with a particle size being “small” among metal particles such as aluminum. Then, the control part 27 displays the count value ML on the display 16, then ends the sub-processing of the output display processing, returns to the main flowchart, and ends the particle measurement processing.

For example, the control part 27 displays, for example, “356” below “count value” on the right side of the target display part 16A (see FIG. 10) of the display 16. Accordingly, the user can easily confirm that the particle detection count of particles with a particle size being “small” among metal particles such as aluminum is “356”.

On the other hand, at the above step S211, in the case of determining that “metal” has not been selected via the operation part 19 as the material for displaying the particle detection count on the display 16 (S211: NO), the processing proceeds to step S219. At step S219, the control part 27 determines whether “resin” has been selected via the operation part 19 as the material for displaying the particle detection count on the display 16. Then, in the case of determining that “resin” has not been selected via the operation part 19 as the material for displaying the particle detection count on the display 16 (S219: NO), the control part 27 executes the processing from step S211 onward again.

On the other hand, in the case of determining that “resin” has been selected via the operation part 19 as the material for displaying the particle detection count on the display 16 (S219: YES), the control part 27 proceeds to step S220. At step S220, the control part 27 displays “resin” as the material for displaying the particle detection count on the display 16, and then proceeds to step S2221. For example, the control part 27 displays “resin” below “material” of the target display part 16A (see FIG. 10) of the display 16, and then proceeds to step S221.

At step S221, the control part 27 determines whether “large” has been selected via the operation part 19 as the particle size of resin particles. Then, in the case of determining that “large” has been selected via the operation part 19 as the particle size of resin particles (S221: YES), the control part 27 proceeds to step S222. At step S222, the control part 27 displays “large” as the particle size for displaying the particle detection count on the display 16, and then proceeds to step S223. For example, as shown in FIG. 10, the control part 27 displays “large” below “particle diameter” of the target display part 16A of the display 16, and then proceeds to step S223.

At step S223, the control part 27 reads, from the RAM, the count value CH that counts the particle detection count of particles with a particle size being “large” among resin particles such as ABS. Then, the control part 27 displays the count value CH on the display 16, then ends the sub-processing of the output display processing, returns to the main flowchart, and ends the particle measurement processing.

For example, the control part 27 displays, for example, “25” below “count value” on the right side of the target display part 16A (see FIG. 10) of the display 16. Accordingly, the user can easily confirm that the particle detection count of particles with a particle size being “large” among resin particles such as ABS is “25”.

At the above step S221, in the case of determining that “large” has not been selected via the operation part 19 as the particle size of resin particles (S221: NO), the control part 27 proceeds to step S224. At step S224, the control part 27 determines whether “small” has been selected via the operation part 19 as the particle size of resin particles. Then, in the case of determining that “small” has not been selected via the operation part 19 as the particle size of resin particles (S224: NO), the control part 27 executes the processing from step S221 onward again.

On the other hand, in the case of determining that “small” has been selected via the operation part 19 as the particle size of resin particles (S224: YES), the control part 27 proceeds to step S225. At step S225, the control part 27 displays “small” as the particle size for displaying the particle detection count on the display 16, and then proceeds to step S226. For example, the control part 27 displays “small” below “particle diameter” of the target display part 16A (see FIG. 10) of the display 16, and then proceeds to step S226.

At step S226, the control part 27 reads, from the RAM, the count value CL that counts the particle detection count of particles with a particle size being “small” among resin particles such as ABS. Then, the control part 27 displays the count value CL on the display 16, then ends the sub-processing of the output display processing, returns to the main flowchart, and ends the particle measurement processing.

For example, the control part 27 displays, for example, “1327” below “count value” on the right side of the target display part 16A (see FIG. 10) of the display 16. Accordingly, the user can easily confirm that the particle detection count of particles with a particle size being “small” among resin particles such as ABS is “1327”.

As described in detail above, in the particle measurement device 1 according to Embodiment 1, the detection of particles W passing through the detection region 42 is performed based on the received light amount of the passing light passing through the detection region 42. Thus, it is possible to solve the problem that the received light amount changes depending on the reflectivity of the particle W, as occurring in the case of the light diffusion method. In addition, without the influence of the reflectivity of the particle W, the magnitude of the received light amount of the light receiving part 26, i.e., the amplitude value P of the signal waveform, will vary according to the size of the particle W.

Furthermore, since the falling velocity of the particle W varies according to the specific gravity (particle density) of the particle W, the material of the particle W can be identified based on the length of duration of the over-time change in received light amount, i.e., based on the pulse width PW of the signal waveform. Thus, it is possible to distinguish between a metal particle such as aluminum and a resin particle such as ABS based on the pulse width PW of the signal waveform. In other words, according to the above configuration, the size and the material of the particle W can be accurately determined based on the over-time change in received light amount, i.e., based on the amplitude value P and the pulse width PW of the signal waveform. In addition, since the particles W freely falling through the internal space 23 of the flow path part 21 are detected, a device such as a suction pump can be omitted. Thus, a particle measurement device with a small device size can be provided.

The light received by the light receiving part 26 is only the light that has passed through the detection region 42, with the slit 41A blocking light in regions in the vertical up-down direction thereof. Thus, when a particle W passes through the detection region 42, the light receiving part 26 detects light in which a light amount change has occurred in the detection region 42. Herein, since the slit 41A is disposed in the horizontal direction, the change in received light amount due to the particle W freely falling through the internal space 23 of the flow path part 21 becomes steep.

Thus, since it is possible to increase the difference in received light amount between the state in which the particle W is passing and the state in which the particle W is not passing, the size of the particle W can be measured with high accuracy. In addition, with a metal particle such as aluminum and a resin particle such as ABS, since the length of duration of the over-time change in received light amount, i.e., the pulse width PW of the signal waveform, changes steeply according to the falling velocity of the particle W, the material of the particle W can be measured with high accuracy.

Since collimated light is irradiated to the detection region 42 by the light emitting-side lens 33 from the light source 31, the light amount distribution in the detection region 42 can be made more uniform compared to, for example, the case where diffused light is irradiated. Thus, since it is possible to reduce a light amount change that depends on the position of the particle W in the detection region 42, the identification accuracy of the size and the material of the particle W can be enhanced.

The control part 27 displays, on the display 16, the particle detection count of particle sizes “large” and “small” of both metal particles such as aluminum and resin particles such as ABS. Accordingly, since the user can learn about the particle detection count for each size range of particles W and each type of material of particles, it becomes possible to accurately recognize the state of particles present in a specific space. In addition, the control part 27 is capable of transmitting, to the host device 3 such as a PC via the communication part 30, the particle detection count for each size range of particles W and each type of material of particles W, and the total particle detection count. It becomes possible for the user to accurately recognize the state of particles present in a specific space using the host device 3 such as a PC.

### § 4 Modification Examples

### Embodiment 2

Next, a particle measurement device 61 according to Embodiment 2 will be described based on FIG. 11. FIG. 11 is a perspective view schematically showing an example of a schematic configuration of a detection part 62 detecting particles W according to Embodiment 2. For convenience of illustration, members having the same functions as those described in the particle measurement device 1 according to Embodiment 1 above will be labeled with the same reference signs, and descriptions thereof will not be repeated.

The particle measurement device 61 according to Embodiment 2 has almost the same configuration as the particle measurement device 1 according to Embodiment 1. However, as shown in FIG. 11, in the detection part 62, a light emitting-side optical fiber 65 is disposed between the light source 31 and the light emitting-side lens 33. In addition, in the detection part 62, a light receiving-side optical fiber 66 is disposed between the light receiving-side lens 35 and the light receiving element 32. In addition, the light source 31 and the light receiving element 32 are disposed in the main body case 11, and the light emitting-side optical fiber 65 and the light receiving-side optical fiber 66 are disposed instead of the signal line 38.

An exit-side end face of the light emitting-side optical fiber 65 from which light exits and an incident-side end face of the light receiving-side optical fiber 66 into which light enters are disposed opposed to each other with the wall surfaces 21A and 21C of the flow path part 21 interposed therebetween. The light emitting-side lens 33 is disposed between the exit-side end face of the light emitting-side optical fiber 65 and the wall surface 21A. The light receiving-side lens 35 is disposed between the incident-side end face of the light receiving-side optical fiber 66 and the wall surface 21C.

The light source 31 is disposed opposed to an incident-side end face of the light emitting-side optical fiber 65 into which light enters. Thus, the light emitting-side optical fiber 65 guides the light emitted from the light source 31 and emits the light toward the light emitting-side lens 33. The light receiving element 32 is disposed opposed to an exit-side end face of the light receiving-side optical fiber 66 from which light exits. Thus, the light receiving-side optical fiber 66 guides the light collected by the light receiving-side lens 35 and emits the light toward the light receiving element 32.

In addition, the optical axis of the irradiation light irradiated from the light emitting-side optical fiber 65 via the light emitting-side lens 33 and the optical axis of the incident light received by the light receiving-side optical fiber 66 via the light receiving-side lens 35 are disposed to be located on a same optical axis LI that is orthogonal to the vertical direction.

In addition, between the wall surface 21C of the flow path part 21 and the light receiving-side lens 35, a slit member 41 in an approximately rectangular plate shape formed of an opaque resin plate or metal plate that does not transmit light is disposed parallel to the wall surface 21C. In the slit member 41, a narrow-width slit 41A is formed along a direction orthogonal to the vertical direction, i.e., along the horizontal direction, at a position through which the optical axis L1 passes.

As a result, among the collimated light irradiated into the flow path part 21 via the light emitting-side lens 33, the region capable of passing through the slit 41A and reaching the incident-side end face of the light receiving-side optical fiber 66 via the light receiving-side lens 35 becomes a detection region 42 capable of detecting particles W falling through the flow path part 21. Thus, a cross-sectional region corresponding to the detection region 42 in the internal space 23 of the flow path part 21 all becomes the region detecting particles W.

As described in detail above, the particle measurement device 61 according to Embodiment 2 is capable of achieving the same effects as those achieved by the particle measurement device 1 above. Furthermore, in the particle measurement device 61 according to Embodiment 2, since it becomes possible to dispose the light emitting part 25 (see FIG. 3) and the light receiving part 26 (see FIG. 3) in the main body case 11 different from the detection region 42, miniaturization of the structure disposed near the detection region 42 can be realized. Thus, it is possible to achieve miniaturization of the device size and realize a particle measurement device 61 capable of detecting particles in a narrow space.

In addition, in the particle measurement device 61, either one of the light emitting-side optical fiber 65 and the light receiving-side optical fiber 66 may be included. In this case as well, since it becomes possible to dispose the light emitting part 25 (see FIG. 3) or the light receiving part 26 (see FIG. 3) in the main body case 11 different from the detection region 42, miniaturization of the structure disposed near the detection region 42 can be realized. Thus, it is possible to realize a particle measurement device 61 capable of detecting particles in a narrow space.

### MODIFICATION EXAMPLE 1

In the particle measurement device 1 according to Embodiment 1, the pulse width detection part 272 may also detect a pulse width PW at an amplitude of ½ of the amplitude value P of the detection signal inputted from the light receiving circuit 46, and output to the particle determination part 274. Accordingly, it becomes possible for the particle determination part 274 to determine the material of the particle W based on the pulse width PW.

### MODIFICATION EXAMPLE 2

In the particle measurement device 1 according to Embodiment 1, the particle determination part 274 may also determine a particle size “large”, “medium”, or “small” of the particle W according to a size threshold STH1 greater than the amplitude threshold PTH and a size threshold STH2 greater than the size threshold STH1. Specifically, the particle determination part 274 may determine the particle size of the particle W as “small” in the case where the amplitude value P of the detection signal inputted from the pulse amplitude detection part 273 is equal to or greater than the amplitude threshold PTH and less than the size threshold STH1.

In addition, the particle determination part 274 may determine the particle size of the particle W as “medium” in the case where the amplitude value P of the detection signal inputted from the pulse amplitude detection part 273 is equal to or greater than the size threshold STH1 and less than the size threshold STH2. In addition, the particle determination part 274 may determine the particle size of the particle W as “large” in the case where the amplitude value P of the detection signal inputted from the pulse amplitude detection part 273 is equal to or greater than the size threshold STH2. Then, the particle determination part 274 may output the determination result of the particle size of the particle W and the material of the particle W to the particle count part 275. The size threshold STH1 and the size threshold STH2 are stored in the ROM in advance.

### MODIFICATION EXAMPLE 3

In the particle measurement device 1 according to Embodiment 1, multiple pulse width detection parts 272 may also be further provided instead of the pulse amplitude detection part 273, and the amplitude threshold for detecting the pulse width of each pulse width detection part 272 may be set to increase sequentially. Each pulse width detection part 272 may detect a pulse width PW of the detection signal of the particle W at the respective amplitude threshold, and output to the particle determination part 274.

The particle determination part 274 may determine the particle size of the particle W by taking, as the amplitude value P (minimum value) of the detection signal of the particle W, the amplitude threshold of the pulse width detection part 272 with which the pulse width PW becomes approximately zero, among the pulse widths PW inputted from each pulse width detection part 272. In addition, the particle determination part 274 may determine that the material of the particle W is “resin” in the case where the pulse width PW inputted from the pulse width detection part 272 with the amplitude threshold PTH is greater than the pulse width threshold WTH. In addition, the particle determination part 274 may determine that the material of the particle W is “metal” in the case where the pulse width PW inputted from the pulse width detection part 272 with the amplitude threshold PTH is equal to or less than the pulse width threshold WTH.

Accordingly, the size and the material of the particle W can be accurately determined. In addition, since the particle W freely falling through the internal space 23 of the flow path part 21 is detected, a device such as a suction pump can be omitted. Thus, a particle measurement device with a small device size can be provided.

### MODIFICATION EXAMPLE 4

In the particle measurement device 1 according to Embodiment 1, the control part 27 may acquire, as numerical value data, the particle size of the particle W based on the amplitude value P of the detection signal inputted from the pulse amplitude detection part 273. In addition, the control part 27 may acquire, as numerical value data, the particle density (specific gravity) of the particle W based on the pulse width PW of the detection signal inputted from the pulse width detection part 272. Then, the control part 27 may transmit the numerical value data of the particle size and the numerical value data of the particle density (specific gravity) of the particle W to the host device 3 such as a PC via the communication part 20.

Then, in the host device 3 such as a PC, the material of the particle W such as metal or plastic and the size of particles for each type of material may be determined based on the received numerical value data. Then, in the host device 3 such as a PC, detection results, alarm warnings, etc. of the material of the particle W such as metal or plastic, the size of particles for each type of material, the number of passed particles for each size range of particles and each type of material of particles, etc. may be displayed.

### MODIFICATION EXAMPLE 5

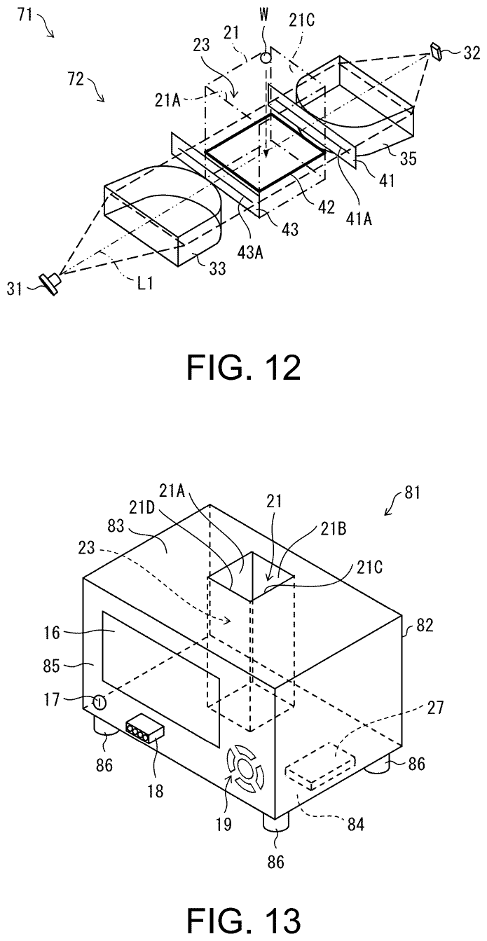

A detection part 72 of a particle measurement device 71 according to Modification Example 5 will be described based on FIG. 12. FIG. 12 is a perspective view schematically showing an example of a schematic configuration of the detection part 72 that detects particles in the particle measurement device 71 according to Modification Example 5. In the following description, constituent elements and members that are identical or equivalent to those of the particle measurement device 1 according to Embodiment 1 will be labeled with the same reference signs, and repeated descriptions will be appropriately omitted.

As shown in FIG. 12, the detection part 72 of the particle measurement device 71 has almost the same configuration as the detection part 30 of the particle measurement device 1 according to Embodiment 1.

However, as shown in FIG. 12, a slit member 43 in an approximately rectangular plate shape formed of an opaque resin plate or metal plate that does not transmit light is also disposed parallel to the wall surface 21A between the light emitting-side lens 33 and the wall surface 21A of the flow path part 21. The height of the slit member 43 in the vertical direction is formed to cover the wall surface 21A until both outer sides in the vertical direction beyond the light emitting-side lens 33. The width of the slit member 43 is formed to cover until both outer sides in a direction orthogonal to the vertical direction beyond the wall surface 21A.

In the slit member 43, a narrow-width slit 43A is formed along a direction orthogonal to the vertical direction, i.e., along the horizontal direction, at a position through which the optical axis L1 passes. Both ends of the slit 43A in the direction orthogonal to the vertical direction are formed to be opposed to outer sides of both side edges of the wall surface 21A.

As a result, among the collimated light irradiated into the flow path part 21 via the light emitting-side lens 33, only the collimated light that passes through the slit 43A is capable of being irradiated toward the detection region 42. Thus, it is possible to restrict the collimated light irradiated into the flow path part 21 via the light emitting-side lens 33 from spreading in the vertical direction to prevent irradiation to outside the detection region 42.

### MODIFICATION EXAMPLE 6

A particle measurement device 81 according to Modification Example 6 will be described based on FIG. 13. FIG. 13 is an external perspective view schematically showing an example of the particle measurement device 81 according to Modification Example 6. In the following description, constituent elements and members that are identical or equivalent to those in the particle measurement device 1 according to Embodiment 1 will be labeled with the same reference signs, and repeated descriptions will be appropriately omitted.

As shown in FIG. 13, the particle measurement device 81 includes a box-shaped main body case 82 in which the main body case 11 and the detection part 30 are integrated, and four leg parts 86 protruding downward with the same length at the four corners of the bottom surface of the main body case 82. The particle measurement device 81 has a display 16, a power switch 17, an output terminal 18, and an operation part 19 that are disposed on a front side wall surface 85 on the near side in FIG. 13.

On a top surface 83, which is approximately rectangular and flat, of the particle measurement device 81, a flow path part 21 with an approximately rectangular cross-section, through which small particles falling in air are capable of entering, is formed penetrating from the top surface 83 to a bottom surface 84 along the particle passing direction (vertical direction) through which particles pass. The flow path part 21 has an approximately rectangular cross-section formed by each wall surface 21A to 21D and constitutes an internal space 23 that penetrates along the vertical direction. Thus, small particles that have entered the flow path part 21 fall freely through the internal space 23. The wall surfaces 21A and 21C are formed of transparent resin or the like and are configured to allow light to pass through.

Thus, in the particle measurement device 81, since particles pass through the flow path part 21 by free fall, the particle passing direction is the vertical direction. In addition, a suction pump or the like for drawing particles into the flow path part 21 is not provided. Accordingly, a particle measurement device 81 with a small device size can be provided.

In addition, the detection part 30 (see FIG. 2) detecting small particles that enter the flow path part 21 and fall through the internal space 23 is disposed in the main body case 82. In addition, as shown in FIG. 13, the control part 27 is disposed in the main body case 11. The control part 27 is capable of detecting the material of small particles such as metal or plastic, the size of particles for each type of material, and the number of particles for each size range of particles and each type of material of particles, based on the pulse width and amplitude of the pulse-shaped particle detection signal inputted from the light receiving part 26. Thus, the particle measurement device 81 is capable of achieving the same effects as the particle measurement device 1 according to Embodiment 1.

### MODIFICATION EXAMPLE 7

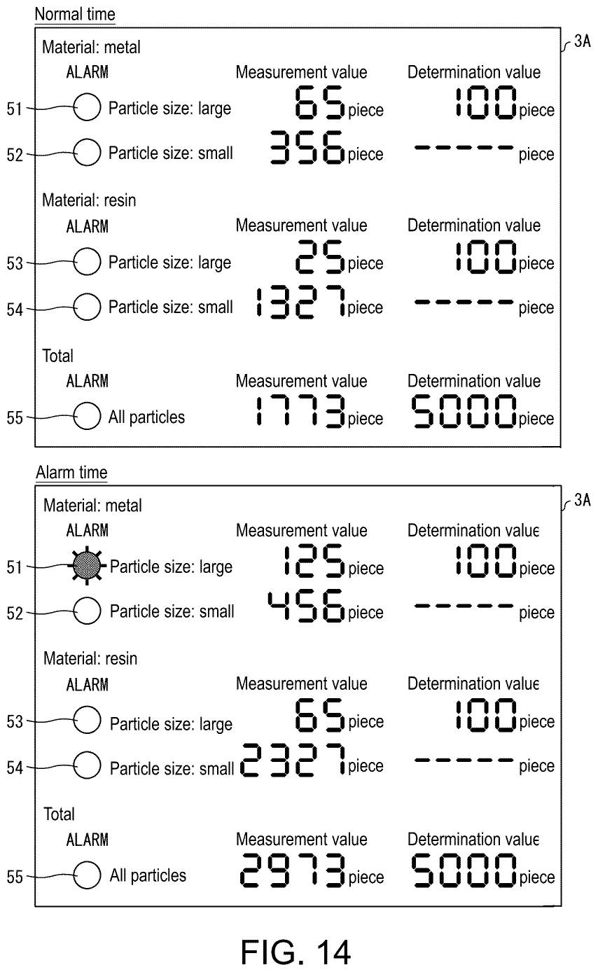

Next, an example of output display of measurement results displayed on a display 3A included in the host device 3 such as a PC according to Modification Example 7 will be described based on FIG. 14. FIG. 14 is a view showing an example of output display of measurement results in the host device 3 according to Modification Example 7.

A first threshold, which is an alarm setting threshold for a particle size being “large” among metal particles, is set to 100 [pieces]. In addition, a third threshold, which is an alarm setting threshold for a particle size being “large” among resin particles, is set to 100 [pieces]. In addition, the settings of a second threshold, which is an alarm setting threshold for a particle size being “small” among metal particles, and a fourth threshold, which is an alarm setting threshold for a particle size being “small” among resin particles, have been canceled. In addition, a fifth threshold, which is an alarm setting threshold for a total particle detection count, is set to 5000 [pieces].

As shown in FIG. 14, on the display 3A, a heading “material: metal” representing metal particles is displayed on the upper left side, a heading “material: resin” representing resin particles is displayed on the intermediate left side, and “total” representing the total particle detection count is displayed on the lower left side. Below each of “material: metal”, “material: resin”, and “total”, columns of “ALARM”, “measurement value”, and “determination value” are disposed in the left-right direction.

Then, each of alarm marks 51 and 52 is displayed below the column “ALARM” at the top, each of alarm marks 53 and 54 is displayed below the column “ALARM” in the middle, and an alarm mark 55 is displayed below the column “ALARM” at the bottom. In addition, “particle size: large” indicating that the particle size is “large” is displayed on the right side of each of the alarm marks 51 and 53. “Particle size: small” indicating that the particle size is “small” is displayed on the right side of each of the alarm marks 52 and 54. “All particles” representing the total particle detection count is displayed on the right side of the alarm mark 55.

The count value MH of metal particles is displayed below the column “measurement value” at the top, and further below, the count value ML of metal particles is displayed. The count value CH of resin particles is displayed below the column “measurement value” in the middle, and further below, the count value CL of resin particles is displayed. The count value N representing the total particle detection count is displayed below the column “measurement value” at the bottom.

In addition, the first threshold “100” [pieces], which is the alarm setting value for a particle size being “large” of metal particles, is displayed below the column “determination value” at the top, and further below, the second threshold, which is the alarm setting value for a particle size being “small” of metal particles, would be displayed. However, since the setting of the second threshold, which is the alarm setting value for a particle size being “small” of metal particles, has been canceled, the second threshold is not displayed.

In addition, the third threshold “100” [pieces], which is the alarm setting value for a particle size being “large” of resin particles, is displayed below the column “determination value” in the middle, and further below, the fourth threshold, which is the alarm setting value for a particle size being “small” of resin particles, would be displayed. However, since the setting of the fourth threshold, which is the alarm setting value for a particle size being “small” of resin particles, has been canceled, the fourth threshold is not displayed. The fifth threshold “5000” [pieces], which is the alarm setting value for the total particle detection count, is displayed below the column “determination value” at the bottom.

Then, as shown in the upper part of FIG. 14, the count value MH of the particle size “large” of metal particles is “65” [pieces], which is equal to or less than the first threshold “100” [pieces]. In addition, the count value CH of the particle size “large” of resin particles is “25” [pieces], which is equal to or less than the third threshold “100” [pieces]. Furthermore, the count value N of the total particle detection count is “1773” [pieces], which is equal to or less than the fifth threshold “5000” [pieces]. As a result, each of the alarm marks 51 to 55 is not displayed in a flashing manner, and it is notified that the status is normal.

In contrast, as shown in the lower part of FIG. 14, the count value MH of the particle size “large” of metal particles is “125” [pieces], which is greater than the first threshold “100” [pieces]. In addition, the count value CH of the particle size “large” of resin particles is “65” [pieces], which is equal to or less than the third threshold “100” [pieces]. Furthermore, the count value N of the total particle detection count is “2973” [pieces], which is equal to or less than the fifth threshold “5000” [pieces]. As a result, the alarm mark 51 is displayed in a flashing manner, and a warning notification is provided.

Accordingly, all data may be transmitted from the particle measurement device 1 to the host device 3 to display, on the display 3A of the host device 3, the particle detection count of particle sizes “large” and “small” for both metal particles such as aluminum and resin particles such as ABS, and the total particle detection count. Accordingly, since the user can learn about the particle detection count for each size range of particles W and each type of material of particles, it becomes possible to accurately recognize the state of particles present in a specific space.

The present invention is not limited to the above-described embodiments, and various modifications are possible within the scope shown in the claims. Embodiments obtained by appropriately combining technical means disclosed in different embodiments are also included in the technical scope of the present.

### Supplementary Notes

A particle measurement device of a first aspect includes a light emitting part, a light receiving part, and a control part. The light emitting part emits an irradiation light toward a detection region. The light receiving part detects a passing light passing through the detection region. In a case where an over-time change occurs in a received light amount of the light receiving part, the control part identifies a size of a particle that has passed through the detection region by free fall based on a magnitude of the received light amount during the over-time change, and identifies a material of the particle based on a length of duration of the over-time change.

According to the above configuration, detection of particles passing through the detection region is performed based on the received light amount of the passing light passing through the detection region. Thus, it is possible to solve the problem that the received light amount changes depending on the reflectivity of the particle, as occurring in the case of the light diffusion method.

In addition, without the influence of the reflectivity of the particle, the value of the received light amount of the light receiving part will vary according to the size of the particle. Furthermore, since the falling velocity of the particle varies according to the specific gravity of the particle, the material of the particle can be identified based on the length of duration of the over-time change in received light amount. In other words, according to the above configuration, the size and the material of the particle can be accurately determined based on the over-time change in received light amount. In addition, since the particles in free fall are detected, a device such as a suction pump can be omitted. Thus, a particle measurement device with a small device size can be provided.

A second aspect is the particle measurement device of the first aspect, further including a slit member provided with a slit allowing passage of a part of light irradiated to the light receiving part. The slit member is disposed such that a longitudinal direction of the slit becomes a horizontal direction.

According to the above configuration, the light received by the light receiving part is only the light that has passed through the detection region, with the slit blocking light in regions in the vertical up-down direction thereof. Thus, when a particle passes through the detection region, the light receiving part detects light in which a light amount change has occurred in the detection region. Herein, since the slit is disposed in the horizontal direction, the change in received light amount due to the freely falling particle becomes steep. Thus, since it is possible to increase the difference in received light amount between the state in which the particle is passing and the state in which the particle is not passing, the size of the particle can be measured with high accuracy. In addition, since the length of duration of the over-time change in received light amount changes steeply according to the falling velocity of the particle, the material of the particle can be measured with high accuracy.

A third aspect is the particle measurement device of the first aspect or the second aspect, further including a collimating lens that converts light emitted from the light emitting part into a collimated light and irradiates to the detection region.

According to the above configuration, since collimated light is irradiated to the detection region, the light amount distribution in the detection region can be made more uniform compared to, for example, the case where diffused light is irradiated. Thus, since it is possible to reduce a light amount change that depends on the position of the particle in the detection region, the identification accuracy of the size and the material of the particle can be enhanced.

A fourth aspect is the particle measurement device of any one of the first aspect to the third aspect, in which, in a case where an over-time change of a specific value or more occurs in an output signal from the light receiving part, the control part detects a minimum value of the output signal within the over-time change, and identifies the size of the particle based on the minimum value. According to the above configuration, the size of the particle can be identified by detecting the minimum value of the output signal from the light receiving part.

A fifth aspect is the particle measurement device of any one of the first aspect to the fourth aspect, in which, in a case where an over-time change of a specific value or more occurs in an output signal from the light receiving part, the control part detects a pulse width at a specific value during a decrease in the received light amount of the output signal within the over-time change, and identifies the material of the particle based on the pulse width. According to the above configuration, the material of the particle can be identified by detecting the pulse width of the output signal from the light receiving part.

A sixth aspect is the particle measurement device of any one of the first aspect to the fifth aspect, in which the control part performs control of outputting to a communication part or displaying on a display part a particle detection count for each size range of the particle and each type of material of the particle during a period set in advance. According to the above configuration, since the user can learn about the particle detection count for each size range of particles and each type of material of particles, it becomes possible to accurately recognize the state of particles present in a specific space.

A seventh aspect is the particle measurement device of any one of the first aspect to the sixth aspect, including an optical fiber that performs at least one of: guiding light from the light emitting part to irradiate toward the detection region; and guiding the passing light to the light receiving part. According to the above configuration, since it becomes possible to dispose at least one of the light emitting part and the light receiving part at a location different from the detection region, miniaturization of the structure disposed near the detection region can be realized. Thus, a particle measurement device capable of detecting particles in a narrow space can be realized.

### REFERENCE SIGNS LIST

1, 61, 71, 81 particle measurement device, 16 display, 20 communication part, 25 light emitting part, 26 light receiving part, 27 control part, 31 light source, 32 light receiving element, 33 light emitting-side lens, 41, 43 slit member, 41A, 43A slit, 42 detection region, 65 light emitting-side optical fiber, 66 light receiving-side optical fiber

1. A particle measurement device comprising a light emitting part, a light receiving part, and a control part, wherein
the light emitting part emits an irradiation light toward a detection region,
the light receiving part detects a passing light passing through the detection region, and
in a case where an over-time change occurs in a received light amount of the light receiving part, the control part identifies a size of a particle that has passed through the detection region by free fall based on a magnitude of the received light amount during the over-time change, and identifies a material of the particle based on a length of duration of the over-time change.

2. The particle measurement device according to claim 1, further comprising:
a slit member provided with a slit allowing passage of a part of light irradiated to the light receiving part, wherein
the slit member is disposed such that a longitudinal direction of the slit becomes a horizontal direction.

3. The particle measurement device according to claim 1, further comprising:
a collimating lens that converts light emitted from the light emitting part into a collimated light and irradiates to the detection region.

4. The particle measurement device according to claim 1, wherein
in a case where an over-time change of a specific value or more occurs in an output signal from the light receiving part, the control part detects a minimum value of the output signal within the over-time change, and identifies the size of the particle based on the minimum value.

5. The particle measurement device according to claim 1, wherein
in a case where an over-time change of a specific value or more occurs in an output signal from the light receiving part, the control part detects a pulse width at a specific value during a decrease in the received light amount of the output signal within the over-time change, and identifies the material of the particle based on the pulse width.

6. The particle measurement device according to claim 1, wherein
the control part performs control of outputting to a communication part or displaying on a display part a particle detection count for each size range of the particle and each type of material of the particle during a period set in advance.

7. The particle measurement device according to claim 1, comprising an optical fiber that performs at least one of:
guiding light from the light emitting part to irradiate toward the detection region; and
guiding the passing light to the light receiving part.
